(19) United States
(12) Patent Application Publication
(10) Pub. No.: US 2005/0125457 A1
(43) Pub. Date: Jun. 9, 2005

(54) Integrated element management system for end-to-end network management in next generation network, and network management method thereof

(76) Inventor: Young-Hyun Kang, Seoul (KR)

Correspondence Address: Robert E. Bushnell, Suite 300, 1522 K Street, N.W., Washington, DC, 20005, US

(21) Appl. No.: 10/999,078

(22) Filed: Nov. 30, 2004

(30) Foreign Application Priority Data
Dec. 3, 2003 (KR) 2003-87349

(51) Int. Cl. G06F 12/00

(52) U.S. Cl. 707/200

(57) ABSTRACT

When an integrated EMS (Element Management system) receives an open command for a new subscriber from a telephone office, it forwards the open command to a relevant network element, which will provide a communication line to the subscriber, to perform an open operation, receives, from the relevant network element, physical connection information allocated to the relevant subscriber terminal by the network element and logical subscriber information allocated to the relevant subscriber by a softswitch according to the subscriber open, and stores the information in a database. The EMS performs a virtual management switch function based on the information in the database to manage a link state and correlated information between respective network elements (NEs). The EMS performs the end-to-end management of alarm, configuration, performance, or the like from the subscriber end to the softswitch by interconnecting a logical number of a subscriber (telephone number) and a physical number of a subscriber node (subscriber connection port ID and position information) as well as link information between the network elements, through the virtual management switch function. Accordingly, there is provided an advantage that a communication path from the softswitch to the subscriber terminal in the next generation network can be collectively managed.

### CLAIM OF PRIORITY

This application makes reference to, incorporates the same herein, and claims all benefits accruing under 35 U.S.C. § 119 from an application for ELEMENTMANA GEMENT SYSTEM FOR END TO END NETWORKMANA GEMENT ON THE WHOLE INNEXT GENERA TIONNETWORK AND METHOD THEREOF THE SAME earlier filed in the Korean Intellectual Property Office on 3 Dec. 2003 and there duly assigned Ser. No. 2003-87349.

### BACKGROUND OF THE INVENTION

1. Field of the Invention

The present invention relates to a network management system and, more specifically, to a network management system that performs network management of respective network elements in the next generation network (NGN).

2. Description of the Related Art

The next generation network (NGN) refers to next generation network techniques and services in which voice, data and images can be concurrently accommodated in one network and various additional services, such as Internet telephone and multimedia messaging, can be efficiently supported.

For the sake of a very high-speed subscriber network service in the NGN, disposal may be made for a variety of network elements and several types of backbone equipment dependent on a user's bandwidth request and service environment.

In order to accomplish the network management of such a network, there is a need for the operation of both an element management system (EMS) that manages a group of network elements (NEs) needing specially concentrated management and a network management system (NMS) that performs overall network management.

Such network elements may include a softswitch, an access gateway, a trunk gateway, a signaling gateway, and the like. Each of the network elements is operating a subnetwork centering on the network element.

A simple configuration of an NGN includes network elements (NEs), such as a softswitch, a signaling gateway, a trunk gateway, an access gateway and the like, are connected to a core network. Further, a subscriber gateway and an IP subscriber terminal performing connection via an IP (Internet protocol) network, and subscribers of various×digital subscriber lines (×DSLs), typical telephones and/or private lines are connected to an access network for connecting to the core network, the x digital subscriber lines including, for example, an asymmetric digital subscriber line (ADSL), a single-pair high-speed digital subscriber line (SHDSL), a very high-data rate digital subscriber line (VDSL), or the like.

The signaling gateway performs signaling conversion. The trunk gateway and the access gateway are media gateways performing media conversion, and interwork time division multiplex (TDM)-based public switched telephone network (PSTN) traffic with an Internet protocol (IP) or asynchronous transfer mode (ATM) packet. The trunk gateway is a media gateway that interworks the TDM trunk of a local softswitch with a packet network. The access gateway allows to, in one element, concurrently process voice, data, image services of subscribers that use a variety of types of transmission media, such as various ×DSLs including ADSL, SHDSL and VDSL, general telephones, private lines, or the like.

Here, disposed are individual EMSs, such as a softswitch EMS (SS-EMS), a signaling gateway EMS (SGW-EMS), a trunk gateway EMS (TGW-EMS), an access gateway EMS (AGW-EMS), and the like, which correspond to the respective core network elements connected to the core network.

The EMS comprised per each of the network elements will perform network management of a network element managed by the EMS and of a subnetwork of the network element. However, information cannot be exchanged between different network elements and accordingly various information created by other network elements cannot be recognized.

That is, because EMS is operated for each type of network elements or for each subnetwork, it is possible to exchange information between the EMSs only when interchanging and inter-working information are allowed between respective EMSs. However, it is practically difficult to realize an information exchange with other EMSs since there may be differences in an inter-working protocol and a utilization function between the EMS and the network element and between the EMS and the EMS, and in a management object and a management manner between different companies.

If an alarm is generated at an arbitrary transmission device, for example, a subscriber channel is out of order, the softswitch becomes out of a call. At this time, because there is no way to know which a portion of the transmission device is out of order, a need exists for a task of separately confirming that portion through a check function of an EMS that is disposed for each network element.

Further, failure occurred at each network element and a subnetwork of a relevant network element can be addressed by discovering the failure through the network check of a relevant EMS.

However, no integrated management is performed for respective network elements, and there is no a method by which an intermediate path between one network element and another network element can be checked, which yields poor network management.

Thus, there are problems in that in spite of a single network, a link between heterogeneous network elements in the network, an alarm, an input/output test, or the like cannot be performed, and overall management cannot be effectively performed by an operator.

### SUMMARY OF THE INVENTION

The present invention is conceived to solve the aforementioned and other earlier art problems, and it is an object of the present invention to provide an integrated EMS for end-to-end network management in the next generation network, and a network management method thereof, which allows an operator to easily perform overall network management and facilitates the operation and maintenance from a softswitch to a subscriber terminal.

It is another object to smoothly perform overall management of the NGN network on the subnetwork and network basis, links between subnetworks, a channel up to a subscriber end, and various test and diagnostic functions using them by operating one integrated EMS with respect to various network elements making up the NGN, and to provide additional service control, setup, monitor functions (QoS, SLA, statistics, alarm, etc.), which can be offered to the subscriber.

It is yet another object to collectively manage physical/logical connection information and management information between heterogeneous network elements, between subnetworks, and between a network element and a subnetwork.

It is still another object of the present invention to test and management of the link interval between the network element and another network element as the physical addresses of the network elements can be designated and tested by the integrated EMS.

According to the present invention for achieving such and other objects, there is provided an integrated EMS for end-to-end network management in the next generation network in which individual information of respective network elements (NEs) in a next generation network, composed of several network elements, are managed in an integrated manner.

When the integrated EMS receives an open command for a new subscriber from a telephone office, it sends the open command to a relevant network element, which will provide a communication line to the subscriber, to perform an open operation, receives, from the relevant network element, physical connection information allocated to the relevant subscriber terminal by the network element and logical subscriber information allocated to the relevant subscriber by a softswitch according to the subscriber open, and stores the information in a database. The EMS performs a virtual management switch function based on the information in the database to manage a link state and correlated information between respective network elements (NEs). The EMS performs the end-to-end management of alarm, configuration, performance, or the like from a subscriber end to a softswitch by interconnecting a logical number of a subscriber (telephone number) and a physical number of a subscriber node (subscriber connection port ID and position information) as well as link information between the network elements, through the virtual management switch function.

Each of the network elements managed by the above integrated EMS includes a softswitch, a trunk gateway, an access gateway, an access node, and a subscriber terminal.

The present invention can also be realized as computer-executable instructions in computer-readable media.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a diagram illustrating a configuration of a conventional network system;

FIG. 2 is a diagram illustrating a configuration of a network system using an integrated EMS according to the present invention;

FIG. 3 is a block diagram illustrating a system configuration of an integrated EMS according to the present invention;

FIG. 4 is a diagram illustrating a text file fetched from a softswitch by the subscriber-opening unit of FIG. 3;

FIG. 5 is a diagram illustrating information extracted by the subscriber-opening unit;

FIG. 6 is a diagram illustrating a database table managed by a network management unit;

FIG. 7 is a block diagram illustrating a configuration of the network management unit shown in FIG. 3;

FIG. 8 is a diagram illustrating a subscriber connection/retrieve screen;

FIG. 9 is a diagram showing the subscriber information frame in FIG. 8;

FIG. 10 is a diagram showing an information frame for each service in FIG. 8;

FIG. 11 is a diagram showing the port setup information frame in FIG. 8;

FIG. 12 is a flow chart showing a retrieval operation performed in a database using a method for end-to-end management in an integrated EMS according to the present invention;

FIG. 13 is a flow chart showing end-to-end management performed in communication with each network element using a method for the end-to-end management in an integrated EMS according to the present invention; and

FIG. 14 shows an example of a computer including a computer-readable medium having computer-executable instructions for performing a technique of the present invention.

### DETAILED DESCRIPTION OF THE INVENTION

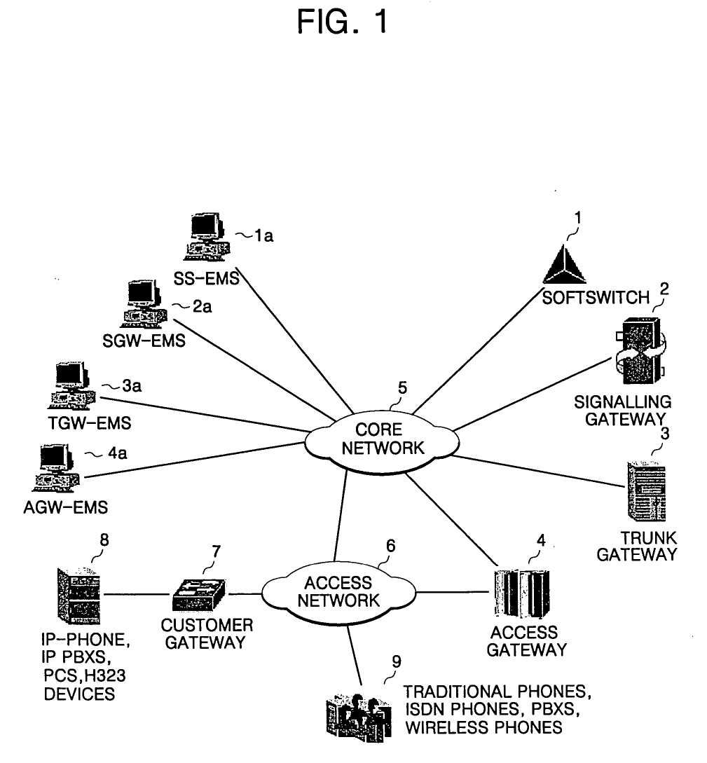

Turning now to the drawings, FIG. 1 is a diagram showing the simple configuration of an NGN.

Referring to FIG. 1, network elements (NEs), such as a softswitch 1, a signaling gateway 2, a trunk gateway 3, an access gateway 4 and the like, are connected to a core network. Further, a subscriber gateway 7 and an IP subscriber terminal 8 performing connection via an IP network, and subscribers 9 of various x digital subscriber lines (×DSLs), typical telephones and/or private lines are connected to an access network 6 for connecting to the core network 5, the x digital subscriber lines including, for example, an asymmetric digital subscriber line (ADSL), a single-pair high-speed digital subscriber line (SHDSL), a very high-data rate digital subscriber line (VDSL), or the like.

The signaling gateway 2 performs signaling conversion. The trunk gateway 3 and the access gateway 4 are media gateways performing media conversion, and interwork time division multiplex (TDM)-based public switched telephone network (PSTN) traffic with an Internet protocol (IP) or asynchronous transfer mode (ATM) packet. The trunk gateway 3 is a media gateway that interworks the TDM trunk of a local softswitch with a packet network. The access gateway 4 allows to, in one element, concurrently process voice, data, image services of subscribers that use a variety of types of transmission media, such as various ×DSLs including ADSL, SHDSL and VDSL, general telephones, private lines, or the like.

Here, disposed are individual EMSs, such as a softswitch EMS (SS-EMS) la, a signaling gateway EMS (SGW-EMS) 2a, a trunk gateway EMS (TGW-EMS) 3a, an access gateway EMS (AGW-EMS) 4a, and the like, which correspond to the respective core network elements connected to the core network.

The EMS comprised per each of the network elements will perform network management of a network element managed by the EMS and of a subnetwork of the network element. However, information cannot be exchanged between different network elements and accordingly various information created by other network elements cannot be recognized.

That is, because EMS is operated for each type of network elements or for each subnetwork, it is possible to exchange information between the EMSs only when interchanging and inter-working information are allowed between respective EMSs. However, it is practically difficult to realize an information exchange with other EMSs since there may be differences in an inter-working protocol and a utilization function between the EMS and the network element and between the EMS and the EMS, and in a management object and a management manner between different companies.

If an alarm is generated at an arbitrary transmission device, for example, a subscriber channel is out of order, the softswitch becomes out of a call. At this time, because there is no way to know which a portion of the transmission device is out of order, a need exists for a task of separately confirming that portion through a check function of an EMS that is disposed for each network element.

Further, failure occurred at each network element and a subnetwork of a relevant network element can be addressed by discovering the failure through the network check of a relevant EMS.

However, no integrated management is performed for respective network elements, and there is no a method by which an intermediate path between one network element and another network element can be checked, which yields poor network management.

Thus, there are problems in that in spite of a single network, a link between heterogeneous network elements in the network, an alarm, an input/output test, or the like cannot be performed, and overall management cannot be effectively performed by an operator.

Hereinafter, the present invention will be described in detail with reference to the accompanying drawings.

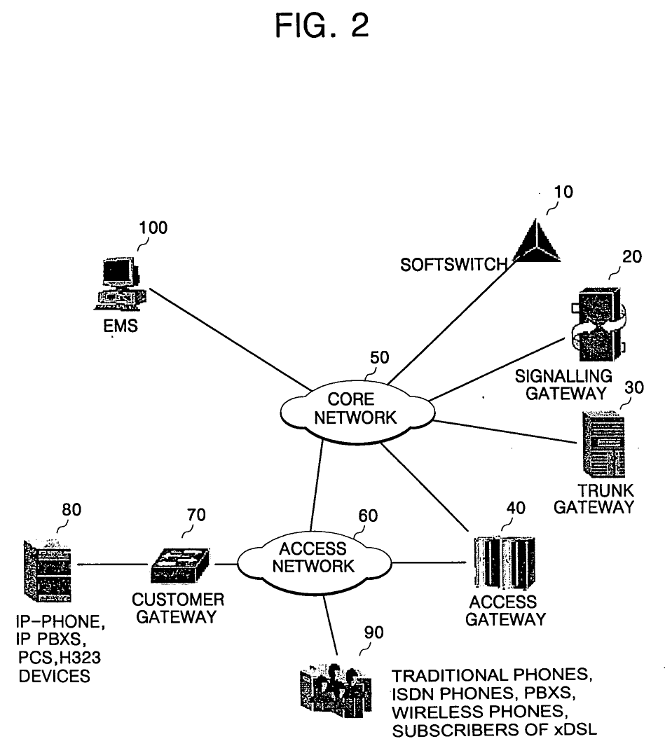

FIG. 2 is a diagram illustrating the configuration of a network system using an integrated EMS according to the present invention.

Referring to FIG. 2, network elements (NEs), such as a softswitch 10, a signaling gateway 20, a trunk gateway 30, an access gateway 40 and the like, are connected to a core network 50. A subscriber (or customer) gateway 70 and an IP subscriber terminal 80 performing connection via an IP (Internet protocol) network, and subscribers 90 of various ×DSLs, such as ADSL, SHDSL, VDSL or the like, general telephones and private lines are connected to an access network 60 for connecting to the core network 50. In addition, an integrated EMS 100 for managing the respective core network elements in an integrated manner is disposed in the core network 50.

The integrated EMS 100 stores, in its database, logical identifier information (e.g., telephone number) that has been allocated to the subscribers by the softswitch 10 and physical connection information of the signaling gateway 20, the trunk gateway 30 and the access gateway 40 that make up a communication path to the subscribers. The integrated EMS performs various inquiry and setup tasks based on the information in the database.

Subscriber information and subscriber connection information of each of the network elements are stored in the database comprised in the integrated EMS 100. The connection information of respective network elements means physical information of respective network elements up to the subscriber terminals. For example, the connection information includes information on racks, shelves, units and ports of the network elements.

If the integrated EMS 100 is disposed in a telephone office, it performs a function of managing in an integrated manner, logical information on subscribers in the softswitch, registered in the softswitch disposed in the telephone office, and information (i.e., physical information) on paths to the subscriber terminals.

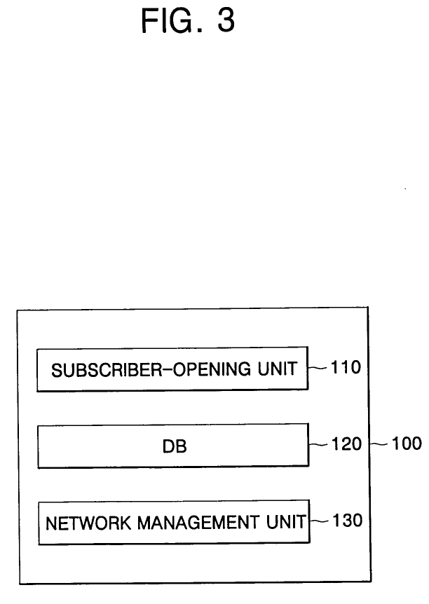

FIG. 3 is a block diagram showing the configuration of an integrated EMS according to the present invention. Referring to FIG. 3, the integrated EMS 100 includes a subscriber-opening unit 110 for receiving logical subscriber registration information allocated to each subscriber from the softswitch 10 in response to a subscriber open request, and sending a subscriber open command to a network element, which will provide a communication path for the relevant subscriber, to receive physical connection information allocated to the subscriber terminal by the relevant network element according to a subscriber open task of the relevant network element; a database 120 for storing the subscriber registration information received from the softswitch 10 and the subscriber connection information received from the network element; and a network management unit 130 for performing end-to-end network management of the communication path from the softswitch to the subscriber terminals 80 and 90, based on the subscriber registration information and the subscriber connection information stored in the database 120 upon receiving an information inquiry and setup request with respect to an arbitrary subscriber.

The subscriber-opening unit 110 receives relevant subscriber information together upon receiving a subscriber open command from the telephone office (not shown). The subscriber-opening unit 110 employs a method of fetching the subscriber registration information from the softswitch 10 via a FTP (file transfer protocol), when receiving the subscriber information from the telephone office.

The Information that the subscriber-opening unit 110 will fetch from the softswitch 10 using the FTP is of a text file format.

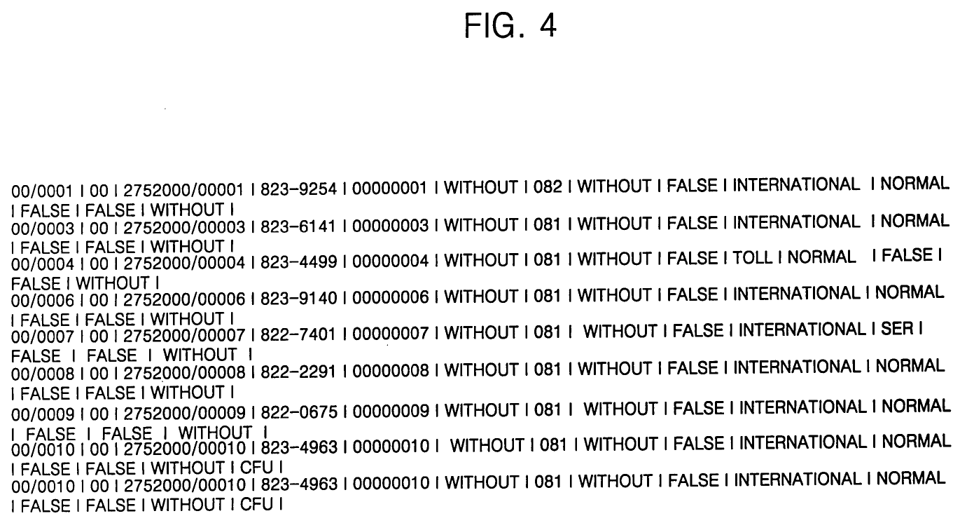

FIG. 4 shows one example of a text file fetched from the softswitch 10 by the subscriber-opening unit 110. This text file includes a variety of stored subscriber information in the softswitch, but the subscriber-opening unit 110 separately extracts only subscriber information needed by the subscriber-opening unit.

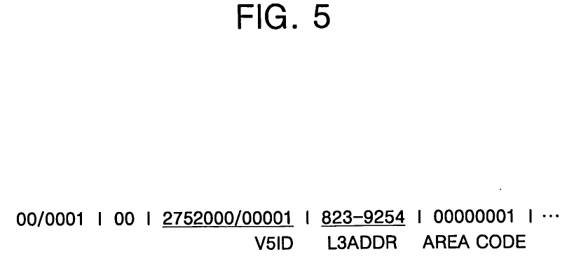

The information needed by the subscriber-opening unit 10 refers to logical information of the softswitch, such as V5id (V5 interface identifier), L3addr (L3 address), an area code, and the like, allocated to the relevant subscriber, as shown in FIG. 5, for example when the subscriber is POTS (plain old telephone service).

The subscriber-opening unit 110 receives softswitch allocation information of a new subscriber from the softswitch 10, and also separately receives personal information or various service information of the subscriber from the telephone office. Such information may be delivered to an operator of the subscriber-opening unit 110 through documents and inputted by the operator. Alternatively, the information may be received in the form of an on-line file from the telephone office, and necessary information may be automatically extracted from the received information and made into a database.

The subscriber-opening unit 110 issues an open command to the signaling gateway 20, the trunk gateway 30 and the access gateway 40, managed by the subscriber-opening unit 10, to perform an open operation for the subscriber terminal in response to the open command for the new subscriber forwarded from the telephone office.

At this time, when the subscriber-opening unit 110 performs the open from the softswitch 10 to the subscriber terminals 80 and 90, it is enough to manage only the information on different types of network elements, namely, the signaling gateway 20, the trunk gateway 30 and the access gateway 40.

This is because, if the subscriber-opening unit 1 10 specifies network elements (e.g., the signaling gateway 20, the trunk gateway 30 and the access gateway 40) covering a communication network of a residential place where an arbitrary subscriber lives and sends a command to open a communication path reaching to the relevant subscriber when the subscriber—opening unit 110—performs the subscriber open with respect to the subscriber, the relevant network element opens the communication path reaching to the subscriber and sends the physical information on the open communication path to the subscriber-opening unit 110.

The subscriber-opening unit 110 will store the physical information, making up the communication path, sent from the relevant network elements (i.e., the signaling gateway 20, the trunk gateway 30, and the access gateway 40) in the database.

The physical information, stored in the database 120 by the subscriber-opening unit 1 10, includes various configuration information of the relevant network element. For example, it includes information on a rack, a shelf, a unit and a port of the relevant network element.

Accordingly, if the subscriber-opening unit 110 completes the open with respect to the arbitrary subscriber, it will receive logical information (representatively, subscriber telephone number) allocated to the relevant subscriber by the softswitch 10 and fetched from the softswitch 10, and physical information of the network element (at least one of the signaling gateway 20, the trunk gateway 30, and the access gateway 40) connecting the communication path from the softswitch 10 to the subscribers 80 and 90 through the subscriber open from the relevant network elements and will store them in the database 120.

Thereafter, the network management unit 130 allows to manage the database 120 and to perform various information inquiry and setup with respect to an arbitrary subscriber. Here, the information inquiry refers to various inquiries with respect to subscribers, the open of which is already made, for example, inquiring the communication path for the relevant subscribers by setting a telephone number range to be retrieved, and inquiry of information on subscribers belonging to an arbitrary network element and receiving services. Further, the setup means a series of setup tasks performed at the time when new subscriber open is required.

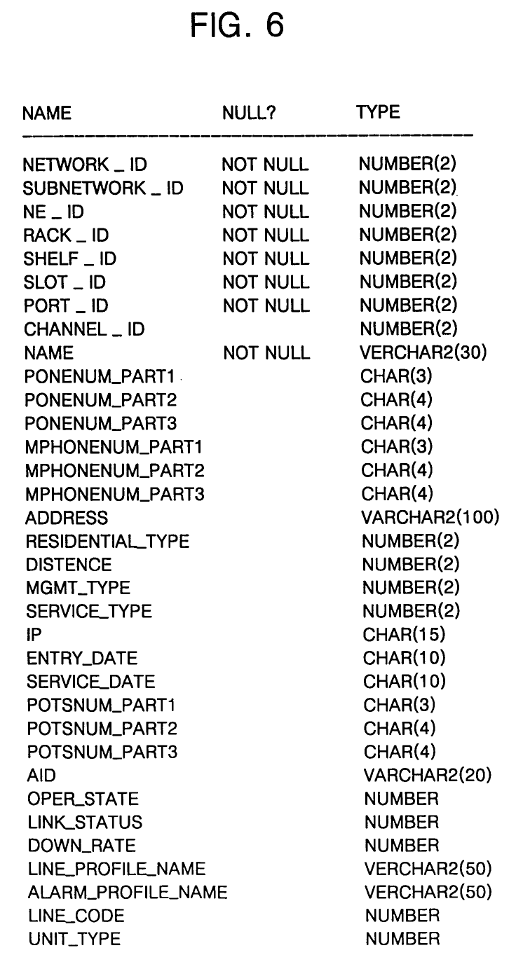

FIG. 6 is an example of a database table managed in the network management unit 130.

Referring to the table, a network identifier NETWORK_ID, a subnetwork identifier SUBNETWORK_ID, a network element identifier NE_ID, a rack identifier RACK_ID, a shelf identifier SHELF_ID, a slot identifier SLOT_ID, a port identifier PORT_ID, a channel identifier CHANNEL_ID, and a user name NAME information are stored therein.

Additionally, in case of a telephone subscriber, various telephone numbers PHONENUM_PART1-MPHONENUME_PART3, an address ADDRESS, a type of residence RESIDENTIAL_TYPE, a distance DISTANCE, a type of management MGMT_TYPE, a type of service SERVICE_TYPE, or the like are stored according the type of the subscriber.

Here, the type of management refers to for example whether or not a subscriber is subscribed at a discount rate that is differently applied depending on the subscribers.

The type of service represents various additional service information utilized for each of subscribers.

Further, when the subscriber is an IP terminal subscriber, IP information, an entry date ENTRY_DATE, a service date SERVICE_DATE, POTS numbers POTSNUM_PART1-POTSNUM_PART3, and the like are stored therein.

Further, when the subscriber is an ISDN subscriber, AID, an operational state OPER_STATE, a down rate DOWN_RATE, a line profile name LINE_PROFILE_NAME, an alarm profile name ALARM_PROFILE_NAME, a line code LINE_CODE, the type of unit UNIT_TYPE, and the like are stored therein.

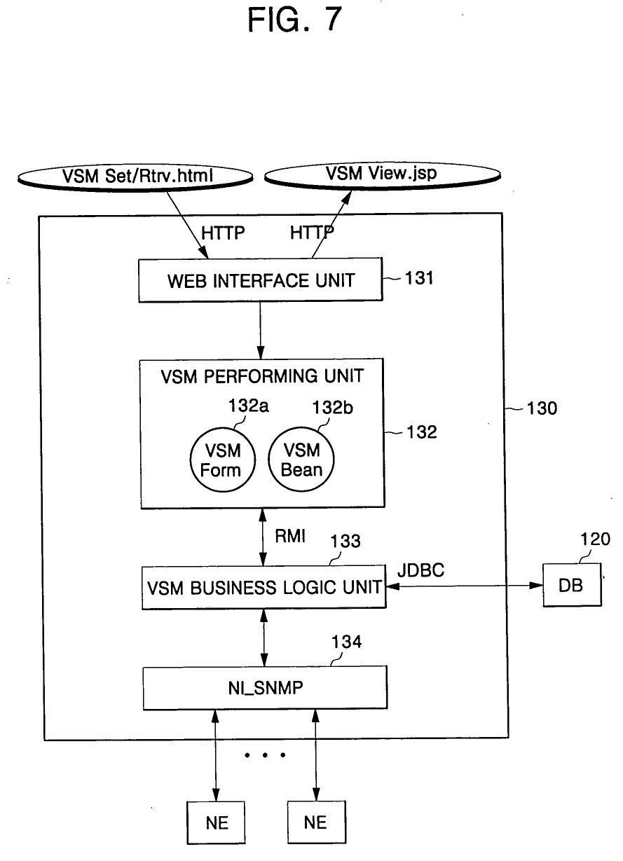

FIG. 7 is a block diagram illustrating the configuration of the network management unit shown in FIG. 3.

Referring to FIG. 7, the network management unit 130 includes a web interface unit 131, a VSM performing unit 132, a VSM business logic unit 133, and a network interface unit 134.

The web interface unit 131 provides a web screen for receiving a command to perform end-to-end network management of an arbitrary network element and for outputting an end-to-end network management result value produced by executing the command. That is, the web interface unit 131 displays a screen (VSM Set/Rtrv.htm) for executing a setup command with respect to a task related to virtual switch management and an inquiry command with respect to a task related to virtual switching. Accordingly, the operator will send the command through a submit command (Submit) on an HTML (hypertext markup language) page after inputting to set up and inquire the virtual switching-related task.

The web interface unit 131 presents a screen (VSM View.jsp) inputting a control command of the operator or the user and at the same time, informing the operator of the processing result or monitored configuration information. At this time, conversation with the operator is performed using a GUI (Graphic User Interface) so that the operator easily confirms. That is, the operator is allowed to easily confirm the state of each network element by diagrammatically representing the result of the monitored configuration information, the relevant processing result originated from the control command, or the like at the same time of inputting the control command of the operator. The VSM View jsp displays the result obtained by executing the VSM inquiry command. Used is a VSM bean 132b, which has been used in the VSM business logic unit 133, in order to indicate the result.

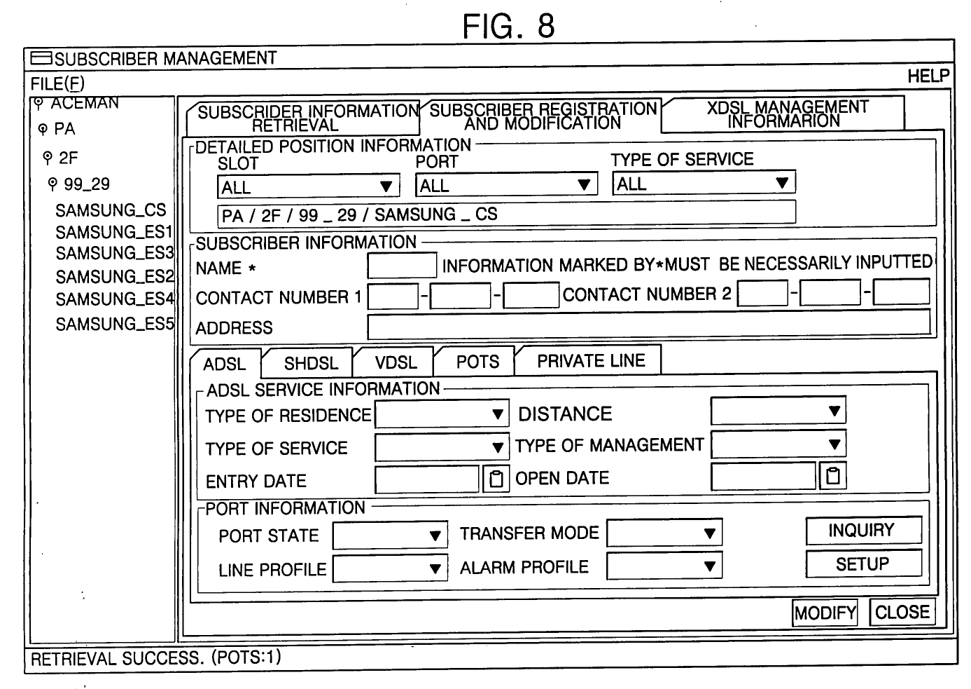

FIG. 8 shows one example of a subscriber connection/retrieval screen.

In the case of registering subscriber information, position information up to the relevant shelf is first selected in a tree and then slot and port information is set on detailed position information. When the selection of the position information is completed, inputting information on the subscriber and then pressing a registration button registers the relevant information in the database.

If the subscriber has been already registered in the selected position information, there will be a modification button in place of the registration button. In the case of modifying the subscriber information, selecting position information up to the relevant port presents the registered subscriber information. At this time, modifying the information and then pressing the modification button modifies the relevant subscriber information.

The configuration of the subscriber management screen will now be discussed. There is a network tree frame at a left side of the screen. That is, the configuration of the network is displayed in the form of a tree and the position information up to the shelf is set.

A detailed position information frame follows. The detailed position information field is a frame for selecting a slot and a port.

Then, there is a subscriber information frame. The subscriber information frame is a frame for inputting information on a subscriber desired for retrieval. I l

There is also an information frame for each of the services (e.g., ADSL, SHDSL, VDSL, POTS, and a private line). This frame is a frame for inputting registration and modification information for each relevant subscriber and service.

The port setup information frame is a frame for inquiring and setting information on each relevant subscriber port.

The subscriber connection information and the softswitch subscriber information are stored in the database and used when a virtual switch management function is performed.

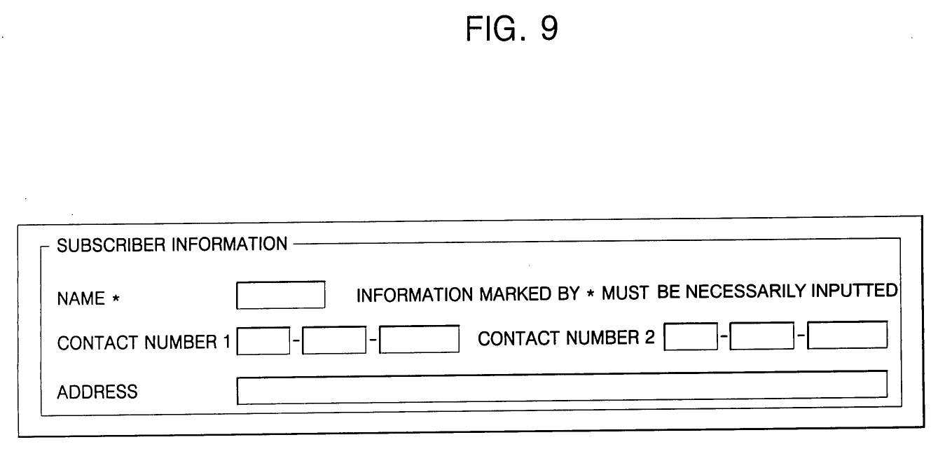

FIG. 9 shows the subscriber information frame. Parameters used in the subscriber information frame include a name, a contact number 1, a contact number 2, and an address. The name is a name of a subscriber to be registered and is composed of 30 or less characters of Hangul and/or Alphabet. The contact number 1 and the contact number 2 are contact numbers of a subscriber to be registered, and consists of digits xxx-xxxx-xxxx. The address is an address of a subscriber to be registered and consists of 100 or less characters of Hangul and/or Alphabet.

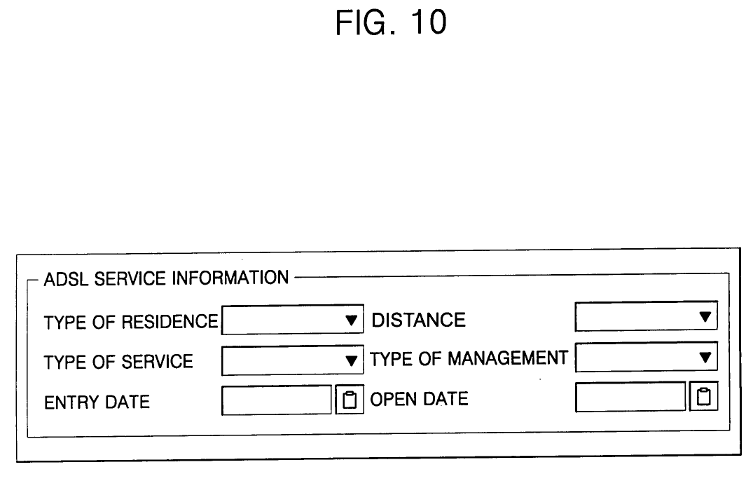

FIG. 10 shows an information frame for each service. Although ADSL is presented on a screen by way of example, services of ×DSL series are equally applied.

The type of residence is to set the subscriber's residential type, such as an apartment (APT), a house, and a building.

The distance is to set the distance of the subscriber line as one of 0-1 km (kilometer), 1-2 km, 2-3 km, 3-4 km, 4-5 km, and 5 km or more.

The type of service is to set the type of a provided service and may be set as one of premium, Lite, MyIP, and MultiIP.

The type of management is to set up ratings managing subscribers, and may include, for example, general rating and special rating. (00941 The entry date and the open date are to set up an entry date and an open date. Pressing a right icon button pops up a calendar window and then the dates are set using the calendar.

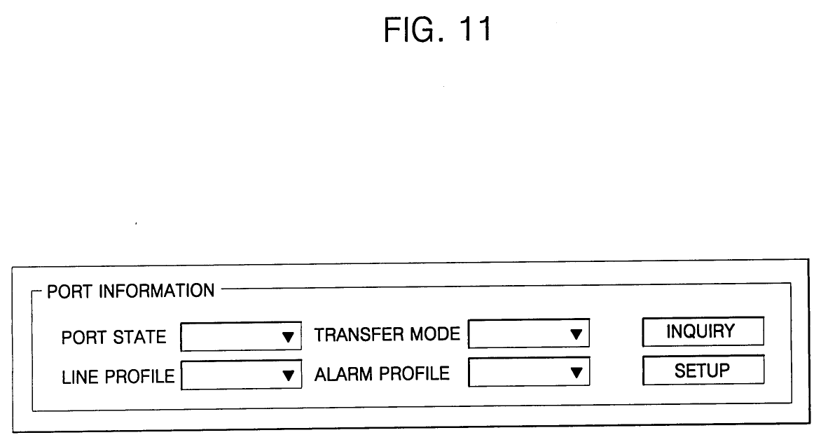

FIG. 11 shows a frame for port setup information.

The port state in the port setup information frame indicates an operational state of the subscriber port and can be selected out of, for example, ACT and DEACT.

The transfer mode indicates a transfer mode of the subscriber port and can be set by selecting one of, for example, T1.413, G.DMT, G.LITE, G. Handshaking, and Auto-detect.

The line and alarm profiles indicate setup profiles of the subscriber ports and mean profiles registered in the NE.

If the VSM performing unit 132 receives a command for the end-to-end network management, the VSM performing unit 132 creates a virtual switch management instance such as a VSM form 132a and a VSM bean 132b, requests the VSM business logic unit 133 to perform the relevant routine, receives and stores the result value in the virtual switch management instance, and sends the value stored in the virtual switch management instance as the end-to-end network management result value.

Here, the bean is a reusable software component that can be visually performed on a developer tool, and is for example the Java beans provided by SUN MICRO SYSTEM. The Java bean is a software component model formulated by a Java language that has portability and is executed independently from a platform. A structure commonly including a member variable xxx and having a method such as getXxx and setXxx that can access the member variable is called a beans form.

The VSM performing unit 132 receives information inputted by the operator via the VSM form instance 132a, and creates the VSM bean instance 132b that represents information on a function to be performed. This bean is delivered as a parameter when the VSM business logic unit 133 calls a function, and is returned including the result obtained after the function of the VSM business logic unit 133 is performed.

The VSM form 132a stores information which is inputted by the operator on the Rtrv.htm. Accordingly, there can exist several types of VSM forms.

The VSM bean 132b stores results obtained by performing respective commands. Accordingly, there can exist several types of VSM beans.

The VSM performing unit 132 calls, via an RMI (Remote Method Invocation), a function of the VSM logic that receives an input from the operator to perform the relevant function.

The RMI is object-oriented communication that gives and takes an object in a Java environment, and is simple and powerful. The RMI is capable of calling and executing a method present in another virtual machine, and uses object serialization to read and write an object stream remotely over a network. The client is able to use the remote method as if the client owns it.

When the VSM performing unit 132 receives the result from the VSM business logic unit 133, it creates VSM viewjsp through the web interface unit 131 so that the result is displayed to the operator through a web browser.

The VSM business logic unit 133 virtually interconnects network aspect information of respective network elements retrieved from the database 120 or from respective network elements via the network interface unit 134 to handle a routine for the end-to-end network management of each network element.

When the VSM business logic unit 133 receives a command signal to manage each 15 network element (NE), it performs the virtual switching function and the end-to-end management of each network element, and outputs the result obtained by processing the received command signal to an EMS client, so that the operator easily confirms the result.

Here, the virtual switch management function means managing the link state and correlated information between respective network elements to perform an arbitrary switching operation so that, although respective network elements are practically operating by means of different protocols, the respective network elements perform relevant tasks as if they operate by means of a single protocol when an arbitrary command is issued by the integrated EMS.

That is, the end-to-end management from a subscriber end to a softswitch, such as alarm, configuration, performance or the like is allowed by interconnecting the logical number of the subscriber (telephone number) and the physical number of a subscriber node (subscriber connection port ID and position information) as well as link information between the network elements, through the virtual management switch function.

Further, the end-to-end management means that the management operation the integrated EMS desires to perform can be performed by designating a point between an arbitrary network element (NE) and another network element by means of the virtual switching function of the integrated EMS.

In addition, the VSM business logic unit 133 includes functions performing a variety of network. management routines so that the VSM business logic unit smoothly performs overall management of an NGN network on the subnetwork and network basis, links between subnetworks, channels up to subscriber ends and various test and diagnosis functions using them, and provides additional service control, setup, and monitor functions (e.g., QoS, SLA, statistics, alarm, etc.) that can be provided to subscribers.

The database 120 stores subscriber connection information of respective network elements collected through the network interface unit 134.

Physical subscriber connection information is stored in the database 120, the physical subscriber connection information being allocated to subscriber terminals by respective network elements, for example, the softswitch, the signaling gateway, the trunk gateway, and the access gateway.

The subscriber connection information is physical connection information of the network elements and includes, for example, information on the racks, shelves, units, and ports of the network elements.

That is, stored are logical numbers of subscribers (telephone numbers) and physical numbers of subscriber nodes (e.g., subscriber connection port IDs (identifications) and position information) as well as link information between network elements, through the virtual management switch function.

For example, in case of network aspect information stored with respect to a subscriber line assigned to an arbitrary subscriber, the network aspect information is greatly classified into switching transmission network information, backbone transmission network information, and subscriber transmission network information.

The switching transmission network information may include subscribers' personal information (representatively, the names of subscribers, such as Chul-Su Kim) and logical numbers is (e.g., 727-3456) allocated to the relevant subscribers by the softswitch.

The backbone transmission network information is information on network elements as a backbone transmission network disposed from the softswitch to the subscribers. Accordingly, if several network elements make up the backbone transmission network, physical numbers will be stored for the respective network elements.

Here, the physical numbers mean the connection port IDs given to subscribers by the relevant network element. More specifically, the physical numbers mean detailed address information on the rack No. (number), shelf No., unit No. and port No. of the relevant element.

Further, port information in an arbitrary network element has respective information on a receiving port that receives data from a network element in the previous stage and on a transmitting port that transmits data to a network element in the next stage.

Accordingly, for example, when a test is performed on a link between a first network element and a second network element, specifying a transmitting port of the first network element and a receiving port of the second network as a range of the test enables a link test between the relevant link intervals to be performed.

The subscriber transmission network information may include subscriber phone numbers (e.g., 727-3456), MAC (media access control) addresses of subscriber terminals, IP addresses, or the like.

In addition, overall management of the NGN network on a subnetwork and network basis, a link between subnetworks, a channel up to a subscriber end and various test and diagnostic results using them according to results of a variety of network management performed for the respective network elements by the VSM business logic unit 133 are stored in the database 120. Also, additional service control, setup, monitor (QoS, SLA, statistics, alarm, etc.) results, which can be provided for the subscriber, are stored in the database 120.

Accordingly, the VSM business logic unit 133 allows to collectively manage physical/logical connection information and management information between heterogeneous network elements, between subnetworks, and between a network element and a subnetwork, using as such the database 120.

The network interface unit (NI_SNMP) 134 communicates with respective network elements making up the next generation network. Here, used is a simple network management protocol (SNMP), which is the most extensively used in the network management network.

The network interface unit 134 translates an internally used data format into SNMP data to send the SNMP data to the relevant network element, and each network element translates back the received SNMP data into the internal data format.

A procedure will be discussed in which the end-to-end management is performed through information inquiry and setup with respect to each network element in the configured integrated EMS.

Basically, when existing information stored in the database is requested by the command from the user, the integrated EMS displays the result of inquiring the DB to the user without inquiring it from each network element. If there is no relevant information in the DB, the EMS requests the relevant network element to present the information, and provides the relevant information for the user.

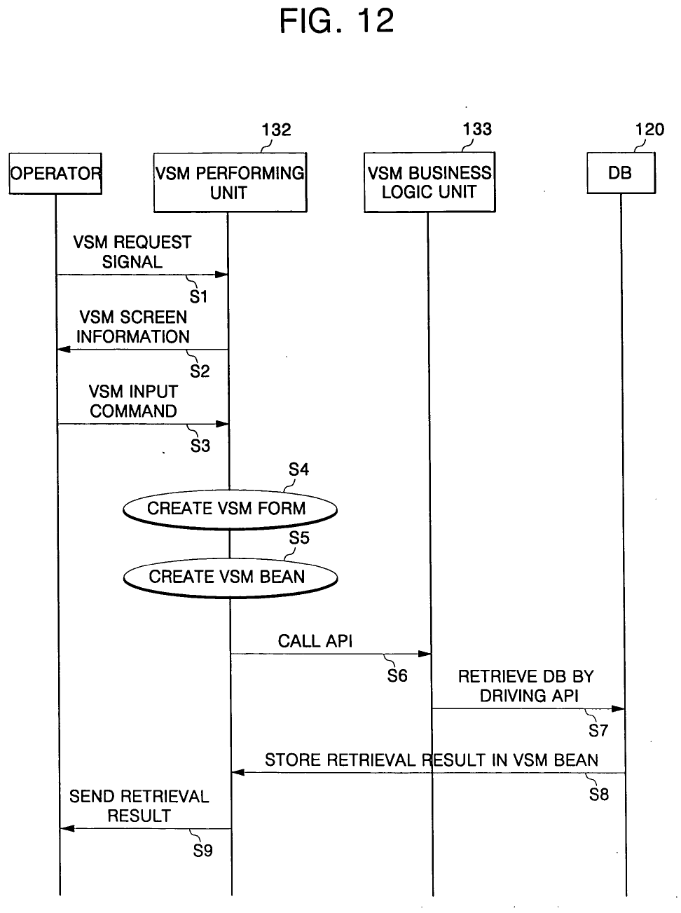

FIG. 12 is a flow chart showing a retrieval operation performed on a database using a method for end-to-end management in an integrated EMS according to the present invention.

First, if the user sends a VSM request signal by clicking a command icon on his or her terminal (not shown) to perform the end-to-end management (S1), the VSM performing unit 132 provides the user's terminal with screen information (VSM Set/Rtrv.htm) via the web interface unit 131, the screen information enabling the user to input any retrieval condition (S2).

At this time, command icons for performing overall management, links between subnetworks, channels reaching to a subscriber end and various test and diagnostic modes, based on various network aspect information that has been stored in the DB 120, and icons for operating additional service control, setup, monitor (QoS, SLA, statistics, alarm, etc.) or the like that can be offered to the subscribers are indicated on the screen information (VSM Set/Rtrv.htm) provided for the user.

The user will input various information into this screen information, the various information being needed for the inquiry or setup task the user desires to perform. For example, the user selects the type of the task and designates a network element or a link interval that becomes an object of the relevant task. At this time, designating the network element and the link interval is accomplished by the user's selection or input of the physical number information of respective II network elements and the detailed address information on the rack No., shelfNo., unit No. and port No. of the relevant element stored in the database 120. 10134] If the user inputs any retrieval condition into this screen information (VSM Set/Rtrv.htm) and then clicks a submit button on the HTML page, the web interface unit 110 sends the information received through the HTTP to the VSM performing unit 132 (S3).

The VSM performing unit 132 creates the VSM form 132a and stores, in the VSM form 132a, the retrieved information that has been inputted from the operator via the web interface unit 131 (S4). In addition, the VSM performing unit 132 creates the VSM bean 132b that will store the retrieval result (S5). The VSM performing unit 132 then calls an application program interface (API) for retrieving the relevant information via the RMI from the DB 120 associated with the VSM business logic unit 133 (S6).

The VSM business logic unit 133, which has the API for retrieving the DB 120 called by the VSM performing unit 132, retrieves the relevant information via the JDBC from the DB 120 (S7) and stores the information in the VSM bean 132b (S8). The JDBC is a Java API for executing SQL within the Java. The JDBC offers a standard API to database and application developers and allows to perform database application tasks only with a pure Java API.

The VSM performing unit 132 creates the retrieval result stored in the VSM bean 132b as a JSP file through the web interface unit 131 to send the file to the operator through the HTTP (hypertext transfer protocol) (S9). Accordingly, the operator is allowed to confirm the retrieval result on the screen of the web browser installed in his or her terminal.

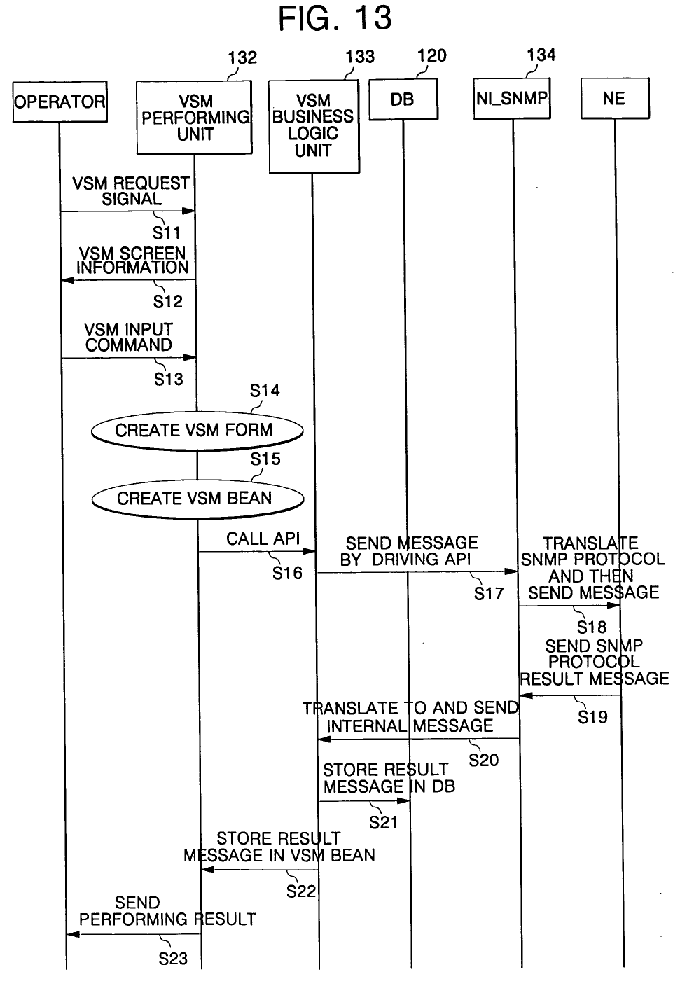

FIG. 13 is a flow chart showing end-to-end management done by performing l I communication with each network element using a method for the end-to-end management in the integrated EMS according to the present invention.

As shown in FIG. 13, the following procedure is performed when the integrated EMS performs a particular setup of arbitrary network elements or directly inquires data from the NEs.

First, if a user clicks a command icon for performing the end-to-end management on his or her terminal (not shown) to send a VSM request signal (S11), the VSM performing unit 132 provides the user's terminal with screen information (VSM Set/Rtrv.htm) via the web interface unit 131, the screen information enabling the user to input the management setup information or the inquiry condition (S12).

If the user enters the management setup information or the inquiry condition into this screen information (VSM Set/Rtrv.htm) and then clicks a submit button on the HTML page, the web interface unit 131 sends the information received through HTTP to the VSM performing unit 132 (S13).

The VSM performing unit 132 creates the VSM form 132a and stores, in the VSM form 132a, the management setup information or the inquiry condition inputted via the web interface unit 131 from the operator (S 14). In addition, the VSM performing unit 132 creates the VSM bean 132b to store the retrieve result (S 15). The VSM performing unit 132 then calls an API for performing the relevant function in the VSM business logic unit 133 via the RMI (S 16).

The VSM business logic unit 133, which has the API for performing a relevant function called by the VSM performing unit 132, sends a setup/inquiry message to the network interface unit 134 (S 17). The network interface unit 134, which receives the setup/inquiry message from VSM business logic unit 133, translates the received message through an SNMP and sends the translated message to the relevant NE (S 18).

The network interface unit 134 receives the result obtained by executing the command using the SNMP from the relevant NE (S 19), and translates the received SNMP data into a message used in the VSM business logic unit 133 to send the translated message to the VSM business logic unit 133 (S20).

The VSM business logic unit 133 stores the result obtained by executing the command in the DB 120 via the JDBC (S21) and also in the relevant VSM bean 132b (S22). The VSM performing unit 132 creates a JSP file using the stored result obtained by performing the command to provide the retrieved result via the web interface unit 131 to the operator (S23).

The present invention can be realized as computer-executable instructions in computer-readable media. The computer-readable media includes all possible kinds of media in which computer-readable data is stored or included or can include any type of data that can be read by a computer or a processing unit. The computer-readable media include for example and not limited to storing media, such as magnetic storing media (e.g., ROMs, floppy disks, hard disk, and the like), optical reading media (e.g., CD-ROMs (compact disc-read-only memory), DVDs (digital versatile discs), re-writable versions of the optical discs, and the like), hybrid magnetic optical disks, organic disks, system memory (read-only memory, random access memory), non-volatile memory such as flash memory or any other volatile or non-volatile memory, other semiconductor media, electronic media, electromagnetic media, infrared, and other communication media such as carrier waves (e.g., transmission via the Internet or another computer). Communication media generally embodies computer-readable instructions, data structures, program modules or other data in a modulated signal such as the carrier waves or other transportable mechanism including any information delivery media. Computer-readable media such as communication media may include wireless media such as radio frequency, infrared microwaves, and wired media such as a wired network. Also, the computer-readable media can store and execute computer-readable codes that are distributed in computers connected via a network. The computer readable medium also includes cooperating or interconnected computer readable media that are in the processing system or are distributed among multiple processing systems that may be local or remote to the processing system. The present invention can include the computer-readable medium having stored thereon a data structure including a plurality of fields containing data representing the techniques of the present invention.

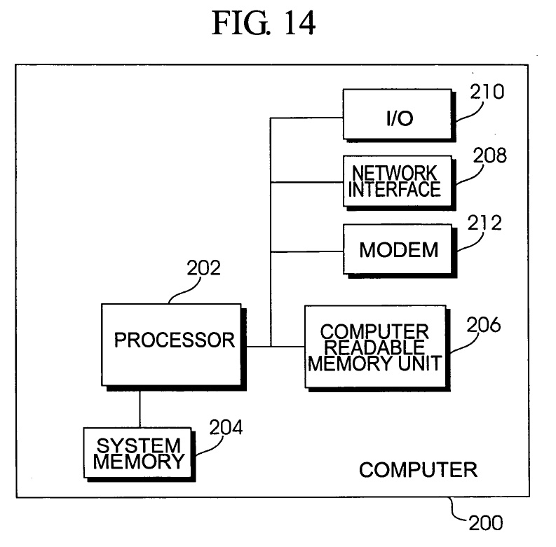

An example of a computer, but not limited to this example of the computer, that can read computer readable media that includes computer-executable instructions of the present invention is shown in FIG. 14. The computer 200 includes a processor 202 that controls the computer 200. The processor 202 uses the system memory 204 and a computer readable memory device 206 that includes certain computer readable recording media. A system bus connects the processor 202 to a network interface 208, modem 212 or other interface that accommodates a connection to another computer or network such as the Internet. The system bus may also include an input and output interface 210 that accommodates connection to a variety of other devices.

According to the present invention, it is possible to smoothly perform overall management of the NGN network on the subnetwork and network basis, links between subnetworks, a channel up to a subscriber end, and various test and diagnostic functions using them by operating one integrated EMS with respect to various network elements making up the NGN, and to provide additional service control, setup, monitor functions (QoS, SLA, statistics, alarm, etc.), which can be offered to the subscriber.

Accordingly, there is provided an advantage that it is possible to collectively manage physical/logical connection information and management information between heterogeneous network elements, between subnetworks, and between a network element and a subnetwork.

For example, although a test is not conventionally allowed as to whether the link interval between one network element and another network element is normal, the present invention allows to test and manage the link interval between the network element and another network element as the physical addresses of the network elements can be designated and tested by the integrated EMS.

Although the preferred embodiments of the present invention have been disclosed for illustrative purposes, they are not intended to limit the scope of the present invention. Those skilled in the art will appreciate that various modifications, additions and substitutions are possible, without departing from the scope of the invention. Therefore, the present invention is not limited to the above-described embodiments, but the present invention is defined by the claims which follow, along with their full scope of equivalents.

1. An integrated element management system for end-to-end network management in a next generation network, comprising:
a subscriber-opening unit for receiving logical subscriber registration information allocated to each subscriber from a softswitch in response to a subscriber open request, and for issuing a subscriber open command to a network element, which will provide a communication path for the relevant subscriber, to receive physical connection information, the physical connection information being allocated to the subscriber terminal by the relevant network element according to a subscriber open task of the relevant network element;
a database for storing the subscriber registration information received from said softswitch and the subscriber connection information received from the network element, for integrated network management; and
a network management unit for managing network elements present on a communication path in an integrated manner, the communication path being established by the subscriber open, through interconnection of the subscriber registration information and the subscriber connection information stored in said database to perform the end-to-end network management of links between the network elements and of subnetworks established by any of the network elements.

2. The element management system according to claim 1, wherein the network management unit comprises:
a network interface unit for performing communication with respective network elements making up the next generation network;
a virtual switch management business logic unit for performing a switching operation with respect to an arbitrary interval of a communication path from said softswitch to said subscriber terminal to handle an end-to-end network management routine according to the physical connection information of each network element inquired from said database or from each network element via said network interface unit; and
a virtual switch management unit for creating an instance for virtual switch management when a command for the end-to-end network management is inputted, requesting the virtual switch management business logic unit to perform the relevant routine, receiving the result value obtained by performing the routine to store the result value in the instance, and sending the value stored in the instance as an end-to-end network management result value.

3. The element management system according to claim 2, further comprising:
a web interface unit for providing a web screen to receive the command for the end-to-end network management of any of the network elements, and to output the end-to-end network management result value produced by executing the command.

4. The element management system according to claim 2, wherein said network interface unit uses a simple network management protocol.

5. The element management system according to claim 2, wherein the information stored in the database comprises at least one of link information between respective network elements, a logical identifier of each subscriber, and a physical identifier of each subscriber node.

6. The element management system according to claim 5, wherein the physical identifier of the subscriber node comprises at least one of rack, shelf, unit, and port information of the network element.

7. The element management system according to claim 2, wherein the network element comprises at least one of a signaling gateway, an access gateway, and a trunk gateway.

8. The element management system according to claim 2, wherein the instance uses a Java form instance and a Java bean.

9. A method for network management in an integrated element management system for integrated network management of network elements, the method comprising the steps of:
receiving logical subscriber registration information, allocated to each subscriber, from a softswitch to store the logical subscriber registration information in a database in response to a subscriber open request;
issuing a subscriber open command to a network element, the network element providing a relevant subscriber with a communication path;
receiving physical connection information allocated to a subscriber terminal by the relevant network element according to the subscriber open task by the network element and storing the physical connection information in the database; and
managing network elements present on a communication path in an integrated manner, the communication path being established according to the subscriber open through interconnection of the subscriber registration information and the subscriber connection information stored in the database, to perform the end-to-end network management of links between the network elements and subnetworks established by any of the network elements.

10. The method according to claim 9, wherein the step of performing the end-to-end network management comprises the sub-steps of:
when a command for the end-to-end network management is inputted, creating an instance for the end-to-end network management of the relevant network element;
calling a relevant routine to perform the end-to-end network management of the relevant network element in response to the inputted command;
by executing the called routine, inquiring the information stored in the database or performing an end-to-end network management operation of the relevant network element requested via a network protocol; and
storing the result value obtained by performing the end-to-end network management in the instance and outputting the value stored in the relevant instance as a network management result value.

11. The method according to claim 10, further comprising the step of providing a web screen to receive the command for the end-to-end network management of any of the network elements and to output the end-to-end network management result value produced by executing the command.

12. The method according to claim 10, wherein the command for the network management comprises the type of task to be performed, subscriber information, and position information or interval information of the network element designated to perform the task.

13. The method according to claim 10, wherein the command for the network management is delivered to the relevant network element using a simple network management protocol.

14. The method according to claim 9, wherein the information stored in said database comprises at least one of link information between respective network elements, a logical identifier of each subscriber, and a physical identifier of each subscriber node.

15. The method according to claim 14, wherein said physical identifier of the subscriber node comprises at least one of rack, shelf, unit and port information of the network element.

16. The method according to claim 9, wherein the network element comprises at least one of a signaling gateway, an access gateway, and a trunk gateway.

17. The method according to claim 10, wherein the instance uses a Java form instance and a Java bean.
